(19) United States
(12) Patent Application Publication
(10) Pub. No.: US 2005/0058033 A1
(43) Pub. Date: Mar. 17, 2005

(54) Optical disk writing method and write power control method thereof

(76) Inventors: Junichi Ishii, Narashino (JP); Takakiyo Yasukawa, Fujisawa (JP); Yutaka Narita, Yokohama (JP); Masashi Imai, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/777,083

(22) Filed: Feb. 13, 2004

(30) Foreign Application Priority Data
Sep. 17, 2003 (JP) 2003-324098

(51) Int. Cl. G11B 5/09; G11B 7/00

(52) U.S. Cl. 369/47.5; 369/53.26; 369/53.37; 369/59.23

(57) ABSTRACT

A specific write power control method used for an optical disk drive is provided. This method relates to how to measure the writing quality and how to set write power for the next zone while settling the linear velocity so that each zone of an optical disk is provided with different linear velocity. At the time of zone switching, writing performed by the head facing an optical disk is interrupted. The head is moved to seek to a given return point in a written area. At the return point, the head is moved toward the next zone, and also a motor for rotating the optical disk is accelerated so that the linear velocity of the motor becomes the linear velocity of the next zone. During the acceleration, the written area is read to measure the writing quality. From the measured writing quality, write power for the next zone is set. At a point of time when the motor reaches the linear velocity of the next zone and the head reaches the next zone, restarting the writing to the optical disk is restarted.

### BACKGROUND OF THE INVENTION

1. Field of the Invention

The present invention relates to a write power control method used for an optical disk drive for writing data by ZCLV (Zoned Constant Linear Velocity), which makes the linear velocity higher as a head gets nearer to the outer circumferential zone.

2. Description of the Related Art

In the ZCLV (Zoned Constant Linear Velocity) for an optical disk, it is necessary to set write laser power at the linear velocity that is different from the linear velocity for the inner circumferential area where test writing is performed. Accordingly, at the time of zone switching, the write laser power is set at different linear velocity that is obtained by performing given arithmetic operation on optimum write laser power based on the result of the test writing. However, with the progress of high-density recording, for example, shifting from the CD-R disk to the DVD-R disk, and the like, and with the speedup of ZCLV, it gradually becomes difficult to obtain optimum write laser power only by the arithmetic processing.

As a method for correcting such write laser power settings, there is known the following technology (refer to Japanese Patent Laid-open No. 2003-85760): at the time of zone switching, reading the last written area of the immediately preceding zone, and measuring asymmetry (β) as a publicly known evaluation measure from a read signal; and from the result of comparison between the measured asymmetry (β) and target asymmetry (β), multiplying the target asymmetry (β) by a given coefficient K, and then adding the multiplied value to initially set power of a next new zone to correct write power for the next new zone.

### SUMMARY OF THE INVENTION

In the ZCLV (Zone Constant Linear Velocity), higher linear velocity is required as a head gets nearer to the outer circumferential zone. Accordingly, when switching a writing zone in order to write data to the next zone, it is necessary to change the linear velocity of the head to that of the next zone.

However, in the above-mentioned correction method, the linear velocity of the next zone is not taken into consideration. Thus, the prior art does not disclose how to measure the writing quality while settling the linear velocity so that each zone in an optical disk is provided with different linear velocity, and how to set write power for the next zone.

In addition, the above-mentioned prior art relating to the correction method only describes that the last written area of the immediately preceding zone is read at the time of zone switching. On the other hand, a return point of the immediately preceding zone is not taken into consideration. Thus, an effective return point is not disclosed at all.

Moreover, in the above-mentioned correction method, as the correction of write power for a new zone, the target asymmetry (β) is multiplied by a given coefficient K, and then the multiplied value is added to initial set power for the next new zone. Accordingly, if there is an error of write power in the current zone, write power for the next new zone is corrected without fixing the error, and consequently optimum correction is not performed.

An object of the present invention is to provide a write power control method of how to measure the writing quality while settling the linear velocity so that each zone in an optical disk is provided with different linear velocity, and of how to set write power for the next zone.

Another object of the present invention is to provide a write power control method capable of shortening a period of time during which the writing is being interrupted when performing zone switching to provide each zone of the optical disk with different linear velocity.

Still another object of the present invention is to provide a write power control method capable of optimally correcting write power for each zone.

The above objects are achieved by a writing method for writing data to an optical disk by a ZCLV method. This writing method comprises the steps of: completing writing to a first zone where the writing is performed at first linear velocity, thereafter evaluating the writing quality of a write signal of the first zone; and with the laser power calculated from the result of the evaluation, performing writing at a second linear velocity to a second zone next to the first zone.

Moreover, the above-mentioned objects are achieved by accelerating a spindle motor to the second linear velocity during the evaluation of the writing quality.

### BRIEF DESCRIPTION OF THE DRAWINGS

FIG. 1 is a configuration diagram illustrating an embodiment of an optical disk drive having a write power control method according to the present invention;

FIG. 2 is a flowchart illustrating a first example of a write power control method used for an optical disk drive;

FIG. 3 is a flowchart illustrating a second example of a write power control method used for an optical disk drive;

FIG. 4 is a flowchart illustrating a third example of a write power control method used for an optical disk drive;

FIG. 5 is a diagram illustrating a configuration of zones in an optical disk;

FIG. 6 is an enlarged partial view of FIG. 5, which illustrates how a head moves from the time at which zone switching of the optical disk occurs until the time at which the head reaches the next zone;

FIG. 7 is a diagram illustrating a change in linear velocity when accelerating a spindle motor to perform the zone switching; and

FIG. 8 is a chart illustrating the relationship between asymmetry (β) and write power.

### DETAILED DESCRIPTION OF THE PREFERRED EMBODIMENTS

Embodiments of the present invention will be described with reference to the drawings.

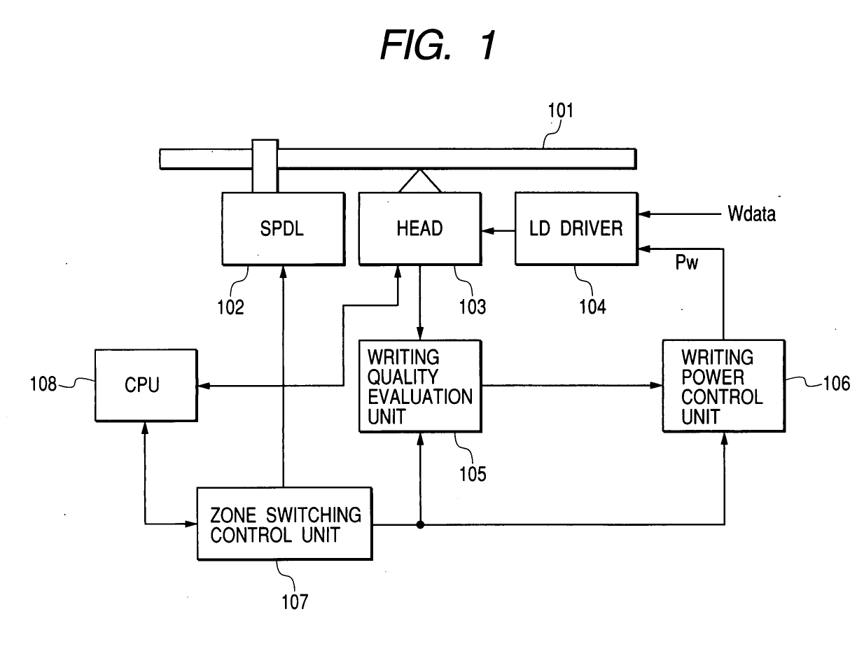

FIG. 1 is a configuration diagram illustrating an embodiment of an optical disk drive implementing write power control methods according to the present invention.

In FIG. 1, reference numeral 101 denotes an optical disk; and reference numeral 102 denotes a spindle motor. The optical disk 101 is rotated by the spindle motor 102 at higher-linear velocity (ZCLV: Zoned Constant Linear Velocity) at a location closer to an outer circumferential zone.

In FIG. 1, reference numeral 103 denotes a head; and reference numeral 104 denotes a LD driver. The head 103 is equipped with a semiconductor laser (LD: Laser Diode). The head 103 moves from the inner circumference toward the outer circumference on the optical disk 101 while reading an address written beforehand to the optical disk 101. In addition, modulating given write power (Pw) with written data (wdata) by the LD driver 104 causes the semiconductor laser to write the data to the optical disk 101.

In FIG. 1, reference numeral 105 denotes a writing quality evaluation unit; and reference numeral 106 denotes a write power control unit. The writing quality evaluation unit 105 measures asymmetry (β), which is a publicly known evaluation measure, from data read by the head 103, and then transmits the asymmetry (β) to the write power control unit 106. By use of the measured asymmetry (β), the write power control unit 106 sets write power used for the next new zone.

In FIG. 1, reference numeral 107 denotes a zone switching control unit; and reference numeral 108 denotes a CPU. When an address read by the head 103 becomes equal to a given number, the CPU 108 notifies the zone switching control unit 107 of it. Subsequently, the zone switching control unit 107 controls the spindle motor 102, the writing quality evaluation unit 105, and the write power control unit 106.

What will be described next in this embodiment is a specific write power control method used for an optical disk drive, which relates to how to measure the writing quality and how to set write power for the next zone while settling the linear velocity so that each zone of an optical disk is provided with different linear velocity.

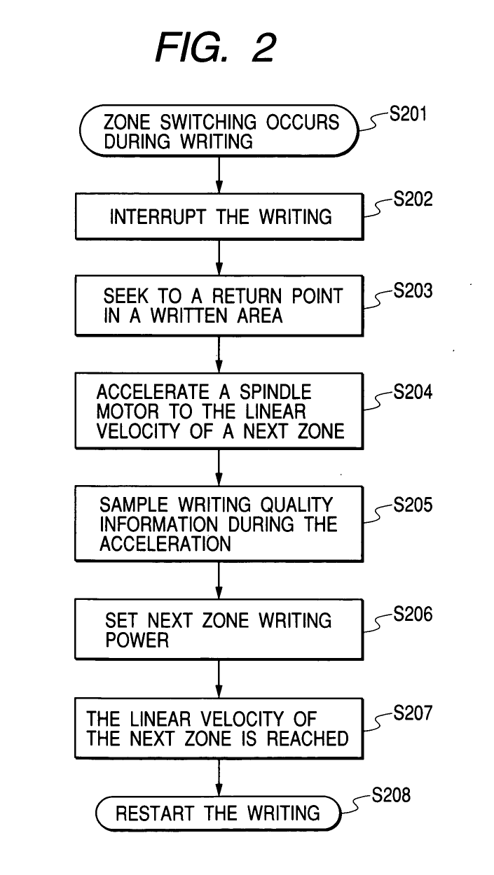

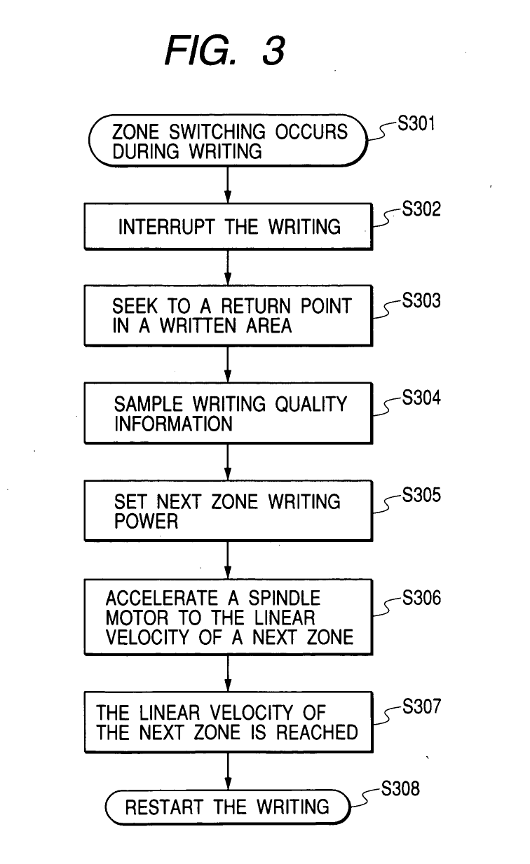

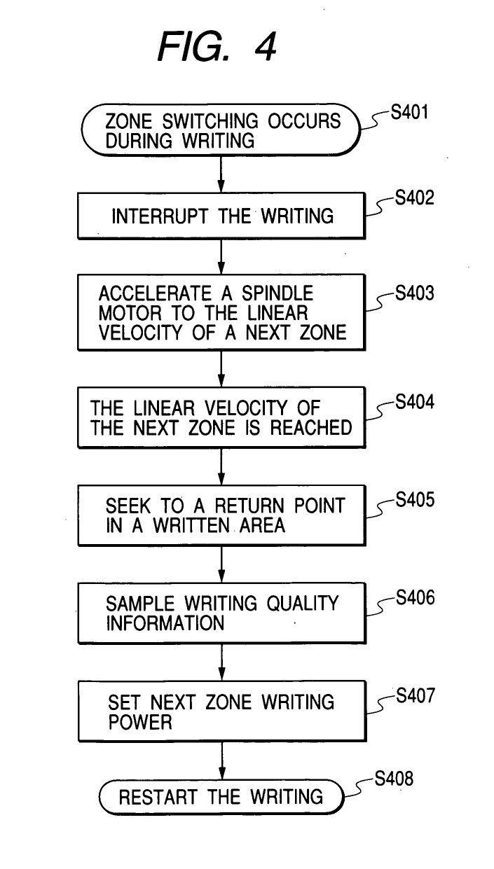

FIG. 2 is a flowchart illustrating a first specific example of a write power control method used for an optical disk drive. FIG. 3 is a flowchart illustrating a second specific example of a write power control method used for an optical disk drive. FIG. 4 is a flowchart illustrating a third specific example of a write power control method used for an optical disk drive.

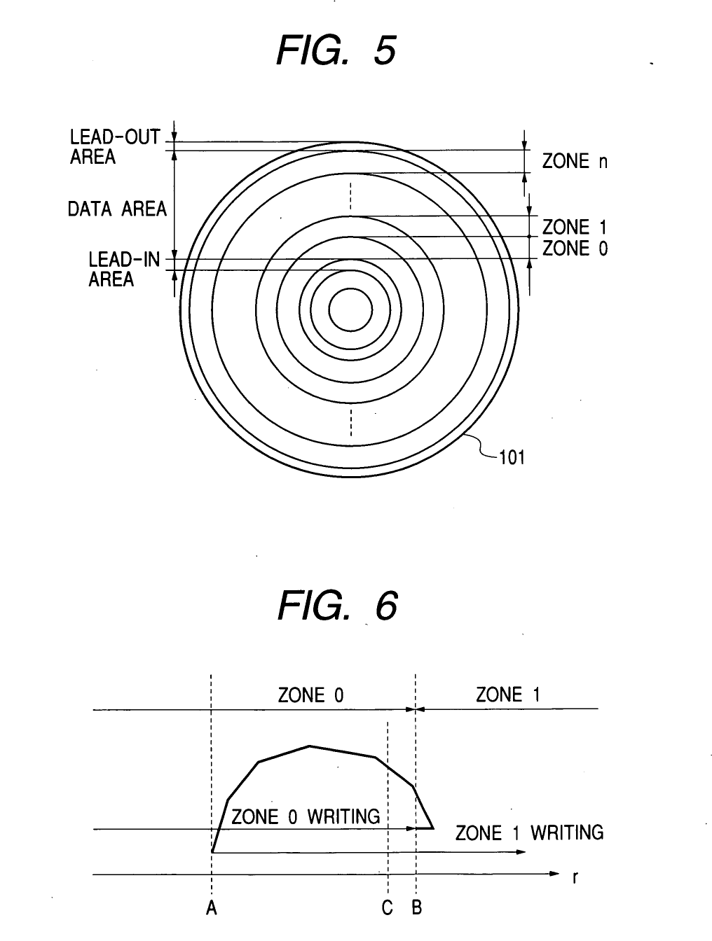

Here, FIGS. 5, 6, 7 will be used with the object of describing the flowcharts in FIGS. 2, 3, 4. FIG. 5 is a diagram illustrating a configuration of zones in an optical disk. FIG. 6 is an enlarged partial view of FIG. 5, which illustrates how a head moves from the time at which zone switching of the optical disk occurs until the time at which the head reaches the next zone. FIG. 7 is a diagram illustrating a change in linear velocity when accelerating a spindle motor to perform the zone switching.

Next, the flowcharts illustrating the first, second, and third specific examples of the write power control method used for the optical disk drive, which are shown in FIGS. 2, 3, 4, will be described.

FIG. 2 is the flowchart illustrating the first specific example. In FIG. 2, to begin with, in step S201, when an address read by the head 103 becomes equal to a given number during writing, zone switching occurs. In FIG. 6, zone switching occurs at point B. Next, in step S202, the CPU 108 judges that the address read by the head 103 has become equal to the given number. Accordingly, the CPU 108 instructs the head 103 to interrupt the writing, and consequently the writing is interrupted.

Next, in step S203, the CPU 108 instructs the head 103 to seek to a given return point in a written area. In FIG. 6, the head 103 is returned to point A.

Next, in step S204, the CPU 108 instructs the head 103 to move toward the next zone. In addition to it, the CPU 108 instructs the zone switching control unit 107 to switch the linear velocity of the spindle motor 102 to that of the next zone. In FIG. 6, acceleration of the spindle motor 102 is started so that at point A the spindle motor 102 rotates at the linear velocity of zone 1 as the next zone.

While the spindle motor 102 is accelerated, in a next step S205, the writing quality evaluation unit 105 measures asymmetry (β), which is a publicly known evaluation measure, from data read by the head 103, and then transmits the asymmetry (β) to the write power control unit 106.

Next, in step S206, by use of the measured asymmetry (i), the write power control unit 106 sets write power used for the next new zone.

Next, in step S207, the spindle motor 102 reaches the next given linear velocity. In FIG. 6, at point C at which time Ts has passed after starting the point A as the acceleration starting position, the linear velocity Vz1 is achieved (refer to FIG. 7). To be more specific, point A is set so that a period of time required for the head 103 to move from point A to point B which is the zone switching point is acceleration time Ts or more, and so that point C which is an acceleration ending position is in proximity to point B.

Next, in a step S208, at a point of time when the head 103 reaches point B shown in FIG. 7, the CPU 108 instructs the head 103 to restart the writing, and consequently the head 103 restarts the writing to the optical disk 101.

FIG. 3 is the flowchart illustrating the second specific example. In FIG. 3, to begin with, in step S301, when an address read by the head 103 becomes equal to a given number during writing, zone switching occurs. In FIG. 6, zone switching occurs at point B where zone 0 is written. Next, in step S302, the CPU 108 judges that the address read by the head 103 has become equal to the given number. Accordingly, the CPU 108 instructs the head 103 to interrupt the writing, and consequently the writing is interrupted.

Next, in step S303, the CPU 108 instructs the head 103 to seek to a given return point in a written area. In FIG. 6, the head 103 is returned to point A.

Next, in step S304, the CPU 108 instructs the head 103 to move toward the next zone. In addition to it, the writing quality evaluation unit 105 measures asymmetry (β), which is a publicly known evaluation measure, from data read by the head 103, and then transmits the asymmetry (β) to the write power control unit 106.

Next, in step S306, by use of the measured asymmetry (β), the write power control unit 106 sets write power used for the next new zone.

Next, in step S306, the CPU 108 instructs the zone switching control unit 107 to switch the linear velocity of the spindle motor 102 to that of the next zone. In FIG. 6, the linear velocity of the spindle motor 102 is switched to the linear velocity of the next zone 1 at point A. Accordingly, the spindle motor 102 is accelerated according to a characteristic shown in FIG. 7.

Next, in step S307, the spindle motor 102 reaches the next given linear velocity. In FIG. 6, at point C of FIG. 6 at which a period of time Ts of FIG. 7 has passed after the acceleration, the spindle motor 102 reaches the given linear velocity Vz1 of the next zone.

Next, in step S308, at a point of time when the head 103 reaches point B shown in FIG. 7, the CPU 108 instructs the head 103 to restart the writing, and consequently the head 103 restarts the writing to the optical disk 101.

FIG. 4 is the flowchart illustrating the third specific example. In FIG. 4, to begin with, in step S401, when an address read by the head 103 becomes equal to a given number during writing, zone switching occurs. In FIG. 6, zone switching occurs at point B where zone 0 is written. Next, in step S402, the CPU 108 judges that the address read by the head 103 has become equal to the given number. Accordingly, the CPU 108 instructs the head 103 to interrupt the writing, and consequently the writing is interrupted.

Next, in step S403, the CPU 108 instructs the zone switching control unit 107 to switch the linear velocity of the spindle motor 102 to that of the next zone. In FIG. 6, the linear velocity of the spindle motor 102 is switched to the linear velocity of the next zone 1 at point A. Accordingly, the spindle motor 102 is accelerated according to the characteristic shown in FIG. 7.

Next, in a step S404, the spindle motor 102 reaches the next given linear velocity.

Next, in a step S405, the CPU 108 instructs the head 103 to seek to a given return point in a written area. In FIG. 6, the head 103 is returned to point A.

Next, in step S406, the CPU 108 instructs the head 103 to move toward the next zone. In addition to it, the CPU 108 also instructs the zone switching control unit 107. As a result, the writing quality evaluation unit 105 measures asymmetry (β), which is a publicly known evaluation measure, from data read by the head 103, and then transmits the asymmetry (β) to the write power control unit 106.

Next, in step S407, by use of the measured asymmetry (β), the write power control unit 106 sets write power used for the next new zone.

Next, in step S408, at a point of time when the head 103 reaches the point B shown in FIG. 7, the CPU 108 instructs the head 103 to restart the writing, and consequently the head 103 restarts the writing to the optical disk 101.

Up to this point, the first, second, and third specific examples of the write power control method used for the optical disk drive have been described.

In particular, in the first example among the first, second, and third specific examples, as shown in steps S204 and S205, while the spindle motor 102 is accelerated so that its linear velocity becomes that of the next zone, asymmetry (β), which is a publicly known evaluation measure, is measured from data read by the head 103. This eliminates the need for the acceleration time during which the spindle motor 102 is accelerated to achieve the linear velocity of the next zone. Accordingly, it is possible to shorten a period of time during which the writing is being interrupted at the time of zone switching.

Moreover, in this embodiment, at the time of zone switching, the writing by the head 103 facing the optical disk 101 is interrupted, and then, the head 103 seeks to a given return point A in the written area. At this time, the return point A is set so that the return point A exceeds a section A-C ranging from a point at which the acceleration of the spindle motor 102 for rotating the optical disk 101 is started with the object of changing the linear velocity of the spindle motor 102 to that of the next zone to a point at which the linear velocity of the spindle motor 102 reaches that of the next zone, and so that the return point A is in proximity to the section A-C. Therefore, it is possible to shorten a period of time during which the writing is being interrupted when performing the zone switching to provide each zone of the optical disk with different linear velocity.

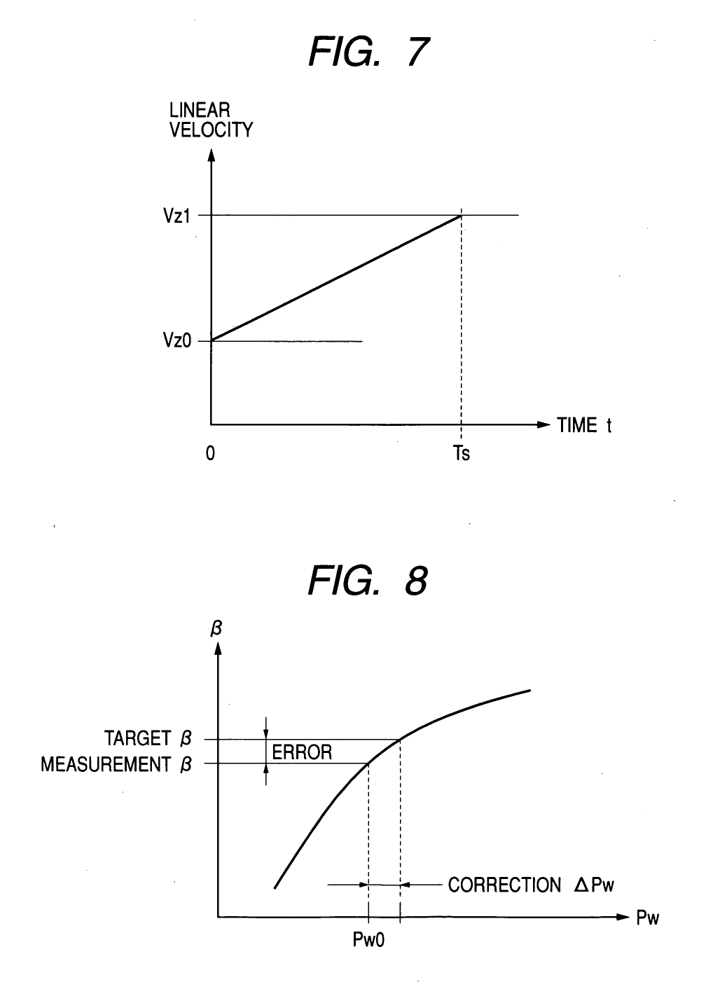

Next, this embodiment will be described with respect to a setting method by which after the writing quality evaluation unit 105 measures asymmetry (β), which is a publicly known evaluation measure, from data read by the head 103, the write power control unit 106 sets write power used for a next new zone by use of the measured asymmetry FIG. 8 is a chart illustrating the relationship between asymmetry (β) and write power. In this embodiment, as shown in FIG. 8, if there is an error between measured asymmetry (β) and target asymmetry (β), an error correction value ΔPw is added to write power Pw0 in the current zone to correct the write power Pw0 in the current zone to target write power for the target asymmetry (β). Then, write power Pw1 of the next zone is determined by multiplying the corrected write power by a power increase coefficient.

In other words, the write power Pw1 of the next zone is determined by Equation 1 as shown below.

[Equation 1]
Pw1=c×(Pw0+ΔPw) (Equation 1)
where
c: Pw increase coefficient at the time of zone switching (fixed on a zone basis),
Pw0: write power in the current zone, and
Pw: error correction value of write power in the current zone (changed by the writing quality measurement)

Here, the error correction value ΔPw may also be determined from a linear approximation in early OPC (Optimum Power Control). Alternatively, it may also be determined by use of a table in which asymmetry (β)/write power are stored beforehand on an optical disk basis.

Thus, according to this embodiment, the write power Pw0 in the current zone is corrected to the target write power before the write power for the next zone is determined. Therefore, it is possible to optimally correct the write power for each zone.

1. A writing method for writing data to an optical disk by a ZCLV method, said writing method comprising the steps of:
completing writing to a first zone where the writing is performed at first linear velocity;
evaluating writing quality of a write signal of the first zone; and
performing writing at second linear velocity to a second zone next to the first zone with the laser power calculated from the result of the evaluation.

2. A writing method according to claim 1, wherein:
the number of revolutions of the optical disk is changed so that the linear velocity reaches the second linear velocity while evaluating the quality of a write signal of the first zone.

3. A write power control method used for an optical disk drive for writing data by a ZCLV (Zoned Constant Linear Velocity) method that makes linear velocity higher as a head gets nearer to an outer circumferential zone, said write power control method comprising the steps of:
at the time of zone switching, interrupting writing performed by the head facing an optical disk;
moving the head to seek to a given return point in a written area;
at the return point, moving the head toward a next zone, and also accelerating a motor for rotating the optical disk so that the linear velocity of the motor becomes linear velocity for the next zone;
during the acceleration, reading a written area to measure writing quality of the written area;
from the measured writing quality, setting write power for the next zone; and
at a point of time when the motor reaches the linear velocity for the next zone and the head reaches the next zone, restarting the writing to the optical disk.

4. A write power control method according to claim 3, wherein:
when the measurement of the writing quality is completed, a point at which it is possible to secure the acceleration time required to reach the linear velocity of the next zone is selected as the return point.

5. A write power control method used for an optical disk drive for writing data by a ZCLV (Zoned Constant Linear Velocity) method that makes the linear velocity higher as a head gets nearer to an outer circumferential zone, said write power control method comprising the steps of:
interrupting writing performed by the head facing an optical disk at the time of zone switching;
moving the head to seek to a given return point in a written area;
moving the head toward a next zone at the return point, and reading the written area to measure writing quality of the written area;
setting write power for the next zone from the measured writing quality;
accelerating a motor for rotating the optical disk so that the linear velocity of the motor becomes the linear velocity for the next zone; and
restarting the writing to the optical disk at a point of time when the motor reaches the linear velocity of the next zone and the head reaches the next zone.

6. A write power control method used for an optical disk drive for writing data by a ZCLV (Zoned Constant Linear Velocity) method that makes linear velocity higher as a head gets nearer to an outer circumferential zone, said write power control method comprising the steps of:
interrupting writing performed by the head facing an optical disk at the time of zone switching;
accelerating a motor for rotating the optical disk so that the linear velocity of the motor is changed to the linear velocity for the next zone;
moving the head to seek to a given return point in a written area when the linear velocity of the motor reaches the linear velocity for the next zone;
at the return point, moving the head toward a next zone, and reading the written area to measure the writing quality;
setting write power for the next zone from the measured writing quality; and
restarting the writing to the optical disk at a point of time when the head reaches the next zone.

7. A write power control method used for an optical disk drive for writing data by ZCLV (Zoned Constant Linear Velocity) that makes the linear velocity higher as a head gets nearer to an outer circumferential zone, said write power control method comprising the steps of:
interrupting writing performed by the head facing an optical disk at the time of zone switching;
moving the head to seek to a given return point in a written area;
at the return point, moving the head toward a next one at the return point, and reading the written area to measure writing quality of the written area; and
when setting write power for a next zone by use of the measured writing quality, determining the write power for the next zone by adding an error correction value to write power in a current zone to correct the write power in the current zone to target write power, and then by multiplying the write power by a power increase coefficient at the time of zone switching, so that the write power in the current zone becomes the target write power for the target writing quality.

8. A write power control method according to claim 7, wherein:
said error correction value is determined from a linear approximation in early OPC (Optimum Power Control).

9. A write power control method according to claim 7, wherein:
said error correction value is determined by use of a table in which writing quality/write power are stored beforehand on an optical disk basis.
